(19) United States
(12) Patent Application Publication
(10) Pub. No.: US 2013/0231902 A1
(43) Pub. Date: Sep. 5, 2013

(54) SPINE-BASED ROSETTE AND SIMULATION IN FIBER-COMPOSITE MATERIALS

(71) Applicant: Siemens Product Lifecycle Management Software Inc., (US)

(72) Inventors: Steven Luby, Brookline, MA (US); Johan Arendt Grape, Boxborough, MA (US); Edwin K. Hoff, Maynard, MA (US); Robert S. Flory, Concord, MA (US)

(73) Assignee: Siemens Product Lifecycle Management Software Inc., Plano, TX (US)

(21) Appl. No.: 13/782,031

(22) Filed: Mar. 1, 2013

Related U.S. Application Data
(60) Provisional application No. 61/634,743, filed on Mar. 5, 2012.

(51) Int. Cl. G06F 17/50

(52) U.S. Cl. CPC G06F 17/50
USPC 703/1

(57) ABSTRACT

A system and method for fiber-composite part simulation. A method includes receiving a part model in a data processing system, the part model representing a part to be manufactured using a fiber composite material. The method includes defining a spine for the part model and defining a spine-based rosette for the part model. The method includes simulating and displaying the part according to the part model, the fiber composite material, the spine, and the spine-based rosette.

### CROSS-REFERENCE TO RELATED APPLICATION

This application claims the benefit of the filing date of U.S. Provisional Patent Application 61/634,743, filed Mar. 5, 2012, which is hereby incorporated by reference.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems), and in particular to PDM systems for designing, visualizing, and simulating fiber-based composite materials.

### BACKGROUND OF THE DISCLOSURE

PDM systems manage PLM and other data. Improved systems are desirable.

### SUMMARY OF THE DISCLOSURE

Disclosed embodiments include systems and methods for fiber-composite part simulation. A method includes receiving a part model in a data processing system, the part model representing a part to be manufactured using a fiber composite material. The method includes defining a spine for the part model and defining a spine-based rosette for the part model. The method includes simulating and displaying the part according to the part model, the fiber composite material, the spine, and the spine-based rosette.

The foregoing has outlined rather broadly the features of an embodiment of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have a property of, or the like; and the term “controller” means any device, system or part thereof that controls at least one operation, whether such a device is implemented in hardware, firmware, software, or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates a spine-based rosette in accordance with disclosed embodiments;

FIG. 3 illustrates in-plane and out-of-plane bending in an exemplary simulation in accordance with disclosed embodiments; and

FIG. 4 illustrates a flowchart of a process in accordance with disclosed embodiments.

### DETAILED DESCRIPTION

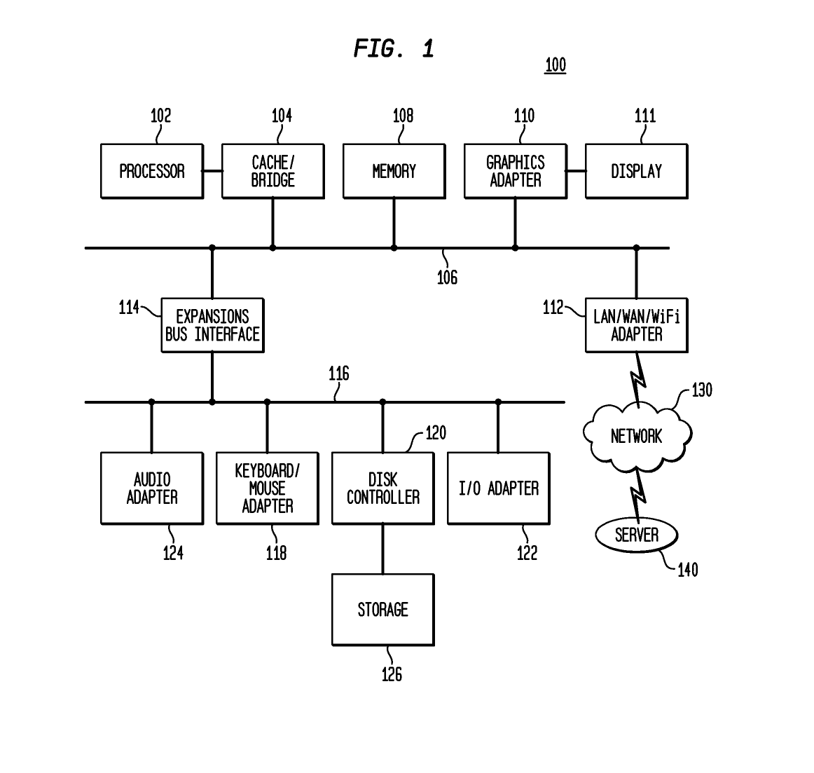

FIGS. 1-4, the discussion below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Various disclosed embodiments include systems and methods that simulate how composite materials conform to 3D stringer geometry or other geometries and predict locations of manufacturing problems due to material conformance. Other embodiments include systems and methods that define a fiber orientation strategy for how composite material fiber orientations should ideally be represented on various parts.

Various embodiments disclosed herein describe systems and methods that provide risk-reducing solutions for industries including those employing composites engineering. Various embodiments enable aerospace, automotive, and wind energy industries to optimize weigh, cost, and performance of composite parts by ensuring fiber orientation matches specifications and to reduce manufacturing flaws such as buckling and delamination.

Disclosed embodiments help reduce risk throughout the aerospace, automotive, and wind energy industries by assisting the user in optimizing the design and manufacture of innovative, durable, and lightweight composite structures. Systems and methods disclosed herein reduce uncertainty in the performance of composite parts by defining, communicating, and validating desired fiber orientations throughout the product development process, ensuring that they meet specifications. By eliminating design interpretation errors, these techniques significantly reduce the risk of producing over-engineered parts that not only behave unpredictably but are also heavier and more costly than necessary.

Specific benefits of disclosed embodiments include increasing opportunities for optimizing designs in the way manufactured composite parts perform by providing a new “spine-based rosette,” described in more detail below, that enables desired fiber orientations to be defined along a path that can then be communicated and validated throughout the development cycle. Maintaining desired fiber orientations in manufactured parts, whether an airframe stringer, an automotive C frame, or a 60-meter wind turbine blade, is critical to optimizing weight and performance.

Disclosed embodiments can accurately simulate how composite materials conform to complex shapes, including advanced material and process simulations for multilayered materials, such as non-crimp fabric and ply forming simulations. Disclosed systems can also simulate a greater number of materials and manufacturing processes by means of a spine-based simulation for parts produced using methods that attempt to force the materials to follow a curved path through space, whether through forced steering of the material or during attempts to make the material conform to a mold (spine-based parts). Forcing the materials to follow the path of an aerostructure stringer, an automotive B pillar, or a scribed line on a wind turbine blade mold, for example, may cause localized buckling and deformation that are detrimental to the performance of the part. The spine-based simulation predicts the formation of such defects, and by identifying these issues early in the design cycle, key decisions can be made to avoid manufacturing defects leading to scrapped tools and parts and to ensure expected part strength is achieved in a timely and cost-effective manner.

Various embodiments can also efficiently communicate a complete part definition between design and analysis, including a breakthrough in the exchange of manufacturing-driven defects such as buckling and deformation between analysts and designers throughout the iterative development cycle. The accuracy of analysis of part stiffness and strength is enhanced through the inclusion of such defects.

FIG. 1 illustrates a block diagram of a data processing system in which an embodiment can be implemented, for example as a PDM system particularly configured by software or otherwise to perform the processes as described herein, and in particular as each one of a plurality of interconnected and communicating systems as described herein. The data processing system illustrated includes a processor 102 connected to a level two cache/bridge 104, which is connected in turn to a local system bus 106. Local system bus 106 may be, for example, a peripheral component interconnect (PCI) architecture bus. Also connected to local system bus in the illustrated example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example illustrated is audio adapter 124, to which speakers (not illustrated) may be connected for playing sounds. Keyboard/mouse adapter 118 provides a connection for a pointing device (not illustrated), such as a mouse, trackball, trackpointer, etc.

Those of ordinary skill in the art will appreciate that the hardware illustrated in FIG. 1 may vary for particular implementations. For example, other peripheral devices, such as an optical disk drive and the like, also may be used in addition or in place of the hardware illustrated. The illustrated example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

The disclosed spine-based rosette and simulation can enable simulation of spine-based composite parts to achieve greater optimization. The disclosed spine-based simulation techniques simulate composite parts that are either designed so that material fibers follow a load path or are steered based on the manufacturing process.

Structural composite parts in aerospace, automotive, and other industries are often designed so that the fibers, and even the part itself, follow a particular load path. The need to follow the load path results in part shapes that are rarely entirely straight. A combination of the shape of the geometry, material selection, and desired fiber orientation can lead to in-plane and out-of-plane buckling of fibers, as well as localized deformation within the part. Fiber buckling and localized deformation can lead to unacceptable loss of strength at critical locations in the part.

Large curved panel or shell parts in wind and marine assemblies are often manufactured by laying large courses of material. Layup of the first course of material is often driven by manufacturability from a part edge or scribe line. Panel or shell curvature forces fibers to be strained by deviating from their natural path within the originally applied course. Subsequent courses are butted or overlapped and continuing to force, and in some cases, amplify fiber strain, leading to fiber buckling and localized deformation. Such defects lead to quality and safety issues that must be addressed, and their discovery during manufacturing, rather than during design, leads to costly waste, inefficiency, part redesign, inconsistency, poor quality, and decreased throughput.

Composite analysts define desired fiber orientations within a part in order to achieve performance based on forces and pressures exerted on the part. Opportunities for greater part optimization are available, but that requires communicating desired part fiber orientations downstream to design and manufacturing. Removing ambiguity can result in the achievement of lower weight and lower cost products that meet part performance.

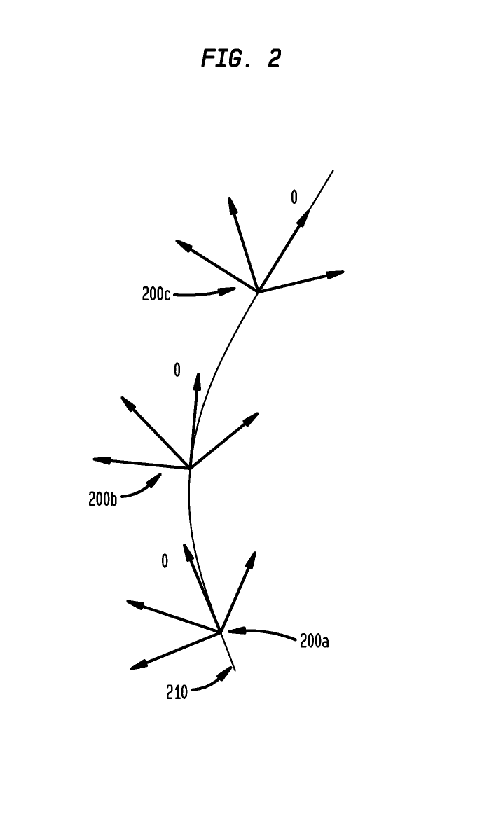

FIG. 2 illustrates spine-based rosette 200a, 200b, and 200c (individually and collectively, spine-based rosette 200) in accordance with disclosed embodiments. Such a spine-based rosette 200 is used to define the desired ideal fiber directions to follow a curved path. In this figure, the “spine” or principal curve of a part or material being designed or simulated is illustrated as curve 210. Curve 210 represents the principle curve of the part, bending and turning as necessary for the design. The spine is the guide-curve used to define the load-path, hence the principal direction of fibers. Those of skill in the art will recognize that while this illustration only illustrates curve 210 bending in the plane of the page, curve 210 can also bend in other directions in three dimensions.

Spine-based rosette 200 illustrates four fiber directions with relation to spine of the part. The spine-based rosette 200 defines the intended fiber-orientations according to a fiber orientation strategy as described herein. The spine-based rosette can be implemented as a coordinate-based system that defines the four principal directions of composite fibers that in equal measure would result in a quasi-isotropic material that is swept along the spine to provide local idealized fiber directions everywhere on the part.

The “0 direction” represents the principal fiber orientation and is directed along the load path at any point on the spine. In most cases, the 0 direction fiber orientation provides the greatest strength of the material for the given load. The other three fiber orientation directions are defined within a plane and with respect to the 0 direction. As illustrated in FIG. 2, the other three fiber orientation directions are at +45°, −45°, and 90° with respect to the 0 direction, in the plane of the material.

The disclosed spine-based rosette provides a means to define desired fiber orientation along a load path or path for manufacturing and provides the ability to understand the deviation of the fibers from the desired orientation as the part is manufactured or simulated.

As illustrated in FIG. 2, the spine-based rosette 200 changes its orientation to reflect the preferred fiber directions at each point on the spine represented by curve 210. At any point, the 0 direction represents the principal orientation and load path, while the other fiber orientations also move to stay at +45°, −45°, and 90° with respect to the 0 direction. Thus, the entire spine-based rosette 200 changes absolute orientation with the spine, as illustrated by rosettes 200a, 200b, and 200c.

The spine-based rosette can be used by a user to specify the desired fiber orientations at any point or can be determined by the system based on the spine path. Once determined for one or more points along the spine, the spine-based rosette data can be stored by the system as associated with the part model or the spine on the part model, and thus can be accessed and used by other systems, including but not limited to downstream manufacturing and analysis systems.

Disclosed embodiments can use the spine-based rosette data, and other fiber orientation and characteristic data, to simulate fiber buckling and localized deformation in the part. The curvature of part geometry and the steering of fibers along a desired path can lead to in-plane and out-of-plane fiber buckling.

In-plane fiber buckling occurs when the part geometry curves but remains in a single geometric plane, generally corresponding to the plane of the fiber directions illustrated by the spine-based rosette. In-plane fiber buckling is a result of fiber tensioning along one side of a part while compressing along the other side. That is, fibers on the “outside” of an in-plane curve are tensioned, while fibers on the “inside” of the in-plane curve are compressed. Because the tensioned fibers generally do not stretch appreciably under the tension applied in a normal manufacturing process, the physical result is often a buckling of the composite along the compressed “inside” of the curve. Various embodiments can simulate these effects and warn of potential buckling or other problems.

Out-of-plane buckling occurs when the part geometry curves out of a single geometric plane, resulting in fiber compression and/or tension as it leaves the original plane or enters a new plane.

Fiber buckling, a form of fiber misalignment, can have significant effects on part performance, as the non-straight fibers contribute very little stiffness to the part, leading to significant loss of rigidity in the affected areas In extreme cases, the buckling can result in significant thickening of the part and the introduction of voids, which result in nucleation sites for crack formation and subsequent catastrophic failure under load. As the tension and compression that occurs due to the steering is often a localized deformation that is relieved as stress in the fibers dissipates throughout part curvature, such defects as fiber buckling can be highly localized and difficult to detect trough simple visual inspection.

Spine-based simulation, in accordance with disclosed embodiments, can identify the areas of fiber buckling and localized deformation. Spine-based simulation provides greater accuracy by providing upstream feedback to analysts as well as the means to make the best design decisions based on existing issues. Addressing those issues early in the design cycle ensures the greatest part optimization, consistent part quality, and the highest manufacturing throughput.

Such a spine-based simulation can simulate the conformance of composite materials to the spine and predicts areas of excessive axial compression in the fibers due to conditions that arise out of geometrically driven deformation resulting from steering the material to conform to the surface of the part along the spine. Such materials include but are not limited to composite fiber-reinforced tape, fabric, or materials provided as an unoriented or oriented mat of fibers. As the simulation predicts the deformation of the material as it is forced to conform to the spine-based part, the simulation determines how much material is used to cover the part and can thus simultaneously also compute the un-deformed flat pattern shape that is required to cover the part.

According to various embodiments, the simulation recognizes that, under normal manufacturing conditions, the composite fibers are effectively inextensible. During the process of making the material conform to the curvature of the surface, the longest path that a fiber takes constrains the remaining material such that all other fibers are in compression. To illustrate, one can consider the steering of the material through a right and then left curve. In the right-hand turn, it is the left-most (outside) fiber of the material that must travel the longest distance, and as it is inextensible, the remaining fibers to the right (or inside) of it must either shorten or buckle. The converse is true of the left-hand turn.

One can easily reproduce the same effect by taking a piece of cellophane tape and sticking it to a surface while making an in-plane bend and simultaneously not stretching the tape. The tape will form small buckles along the inside edge of the bend. The simulation can compute material conformance based on the geometric constraints, and user feedback is provided through post-processing, where user-provided material parameters provide limits on the acceptable quantity of in-plane deformation before the induced fiber waviness creates a complete buckle in the layer of material.

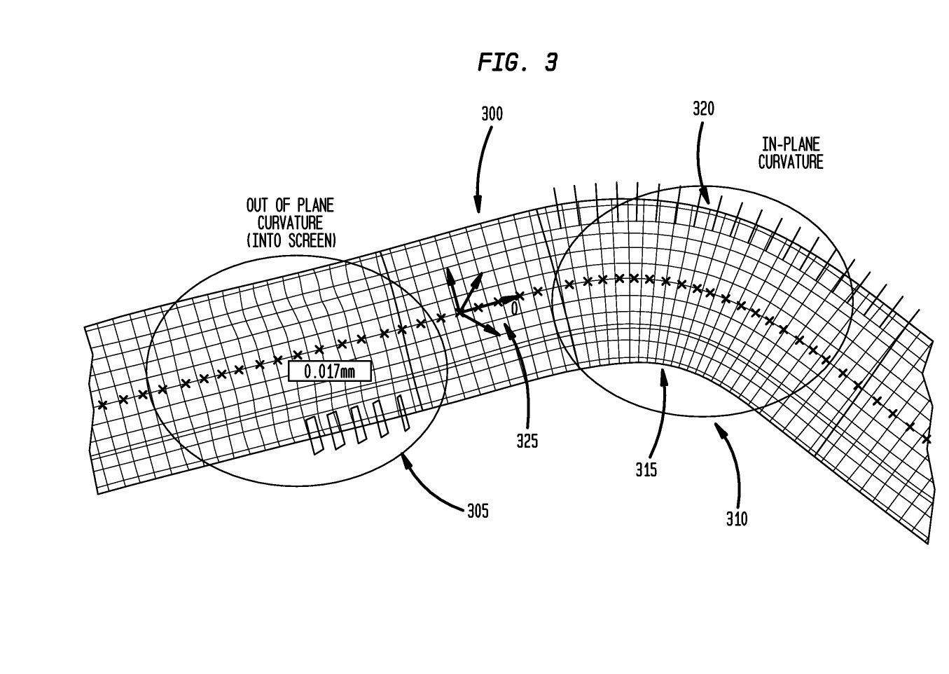

FIG. 3 illustrates in-plane and out-of-plane bending in an exemplary simulation in accordance with disclosed embodiments. In this example, the system simulates fiber composite material 300, and the plane of the material is along the plane of the screen (or of the paper, in a printed figure). In area 305, the system simulates an out-of-plane curvature, in this case, in the direction of the screen (into the paper or away from the view). While not shown in this patent illustration due to drawing limitations, such curvature in the simulation can be represented by coloration of the simulated material itself or of the lines that illustrated the flow direction of the material. In area 310, the system simulates an in-plane curvature. In this example, the simulation can show, by coloring or otherwise, areas of fiber compression, such as at 315, and areas of fiber tensioning, such as at 320.

Further, where the system determines that there may be design problems in the simulation such as potential buckling at 315, the system can use other colors, such as red lines or shading, to alert the designer or user of the potential problem. The system can derive or determine potential problems, including buckling conditions, by comparing the composite material type and the curvature conditions with a database of empirical data of material properties and behaviors, such as may be stored in storage 126. In other embodiments, the system can perform a direct mathematical analysis based on the material properties and curvatures to determine such potential problems.

The system can also display one or more spine-based rosettes in conjunction with the simulation, as illustrated at 325. Note that this spine-based rosette 325 is magnified for the purposes of illustration, and in a typical simulation, a series of smaller spine-based rosettes can be displayed running the length of the spine.

Taken in combination, the various elements discussed above allow a user to specify the intended composite fiber directions for the part via an interaction with the system. The system can quickly simulate the ability of the material to conform to the part without forming buckles, and show potential problems, thereby reducing the risk that such defects are encountered in manufacturing leading to scrap parts. The system can also produce the flat-pattern shape that is required to cover the region of the surface that has been specified.

Disclosed embodiments address specific design and manufacturing problems with load-path following composite stiffeners. In various embodiment, the inputs to the simulation can include the constraint curve (the spine), which also represents the idealized direction of the fibers as represented by the coordinate system (the rosette), the surface on which to run the simulation, and a parameter to control the resolution of the simulation.

The results of the spine-based simulation can also be used with finite-element based models. Disclosed embodiments increase the accuracy of finite element analysis by passing more accurate fiber orientations from manufacturing simulation of fiber-steered parts, and optimize part performance, quality, and throughput by understanding the deviation between the as-analyzed part and the as-manufactured part and making design choices early in development.

A disclosed spine-based rosette allows the user to specify a curve to use as the zero direction of the model. Currently, if the user desires such behavior, he must specify a direction curve for each ply, and each direction curve must pass through the ply's origin, so the user must create a large amount of CAD geometry. Such systems then attempt to get an approximation of the ply's deviation. These deviation measurements will not be accurate as measured against the zero direction of the rosette. The deviation is measured against the zero direction only at the origin, so the deviation at points farther from the origin is not accurate. Disclosed spine-based techniques provide superior results with less user effort and provide much more accurate representation of intended and resulting fiber orientations.

The spine-based rosette is useful in scenarios where the user wishes to specify that the zero-direction of the part follow a curved path through space. The spine is defined through selection of a curve that may or may not be geometrically coincident with the part, and the spine-based rosette provides the mechanism by which the curves tangent direction is mapped onto the part such that it controls the 0 direction everywhere on the part. This differs from industry-standard and prior-art rosette mapping schemes, which do not utilize a curve control.

An exemplary user interaction in accordance with disclosed embodiments can include a user creating a spine-based rosette and selecting or defining a curve to be used as the spine. The curve may or may not be coincident with the part. The system can highlight the spine and display one or more spine-based rosettes. The system can link one or more objects to a spine-based rosette, and the system can then use spine-based mapping for directions and angles.

One process for mapping a direction from the spine, in accordance with disclosed embodiments, can include receiving or defining a spine curve C, an angle θ, and a point p. The system can then find n, the surface normal vector at p. The system can find point q, the point on C closest to p. The system can find t, the tangent vector of C at q. The system can then define the 0 direction fiber orientation as t with respect to point p. The +45°, −45°, and 90° fiber orientations are then defined, in the material plane, with respect to the 0 direction.

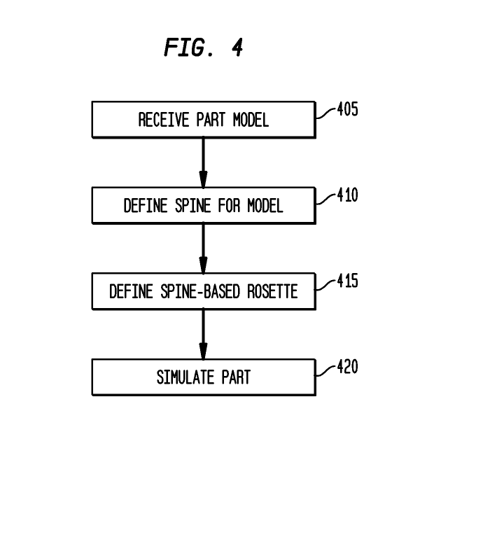

FIG. 4 illustrates a flowchart of a process in accordance with disclosed embodiments. Such a process can be performed by one or more data processing systems, such as data processing system 100, and in particular can be performed by a PDM system.

The system receives a part model (step 405). “Receiving,” as used herein, can include loading from storage, receiving from another device or process, or receiving via an interaction with a user. The part model can include an identification of the material for the part and optionally the property characteristics. The part model can represent a part of an assembly, such as a stringer, spar, or other structure, and preferably represents a part to be manufactured using fiber composite materials.

The system defines a spine for the part model (step 410). The user can specify the spine, which may or may not also be the centerline of the model, so that the system defines the spine by receiving a user selection or indication of a spine or curve to be used as the spine. The spine can be the intended load path, and all the fibers can be designated to follow the spine. The spine need not lie on the surface of the part. In other embodiments, the system can itself define the spine by analyzing the part model and determining the spine according to the geometry of the part model or the anticipated forces to be applied to the part.

The system defines a spine-based rosette (step 415). As part of this step, the system or the user can select or specify the surface of the part and spine-based rosette, and the system can then define the 0-direction fiber orientation in the spine direction at each point along the spine, and the +45°, −45°, and 90° fiber orientations with respect to the 0 direction at some or all points on the spine, in the local tangent plane of the surface. If the spine is not coincident with the surface, in some embodiments, the spine-based rosette can follow a path that minimizes the distance between the spine and the surface, such that the spine-based rosette will appear to follow a projection of the spine onto the surface. In other cases, the spine-based rosette orientations can be mapped to any location of the part either along or away from the spine.

The system simulates the part according to the part model surface, the material, the spine, and the orientation specified relative to the spine-based rosette (step 420). The simulation can include displaying in-plane and out-of-plane curvatures, using lines, coloration, or otherwise. The simulation can include displaying potential design and manufacturing problems, including but not limited to fiber deviation, tensioning, compression, or buckling, using lines, coloration, or otherwise. The system can display one or more spine-based rosettes on the simulated part, including displaying the spine on the part and displaying multiple spine-based rosettes along the spine. The system can display the simulation to a user, send it to another system for display, produce hardcopy or other output of the simulation, and store simulation data for use in other systems or processes. In the simulation, to show fiber deviation, the system can compare the mapped spine-based orientations to the simulation to show deviation of fibers from the ideal orientations shown by the spine-based rosette.

During or after simulation, the system can compute an undeformed flat pattern of the material, from the simulation, that corresponds to the simulated part model.

Of course, those of skill in the art will recognize that, unless specifically indicated or required by the sequence of operations, certain steps in the processes described above may be omitted, performed concurrently or sequentially, or performed in a different order.

Those skilled in the art will recognize that, for simplicity and clarity, the full structure and operation of all data processing systems suitable for use with the present disclosure is not being illustrated or described herein. Instead, only so much of a data processing system as is unique to the present disclosure or necessary for an understanding of the present disclosure is illustrated and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method performed by one or more data processing systems, comprising:
receiving a part model in a data processing system, the part model representing a part to be manufactured using a fiber composite material;
defining a spine for the part model by the data processing system;
defining a spine-based rosette for the part model by the data processing system; and
simulating and displaying the part according to the part model, the fiber composite material, the spine, and the spine-based rosette.

2. The method of claim 1, wherein the spine-based rosette indicates fiber orientations for the part model at a point along the spine, the fiber orientations including a 0-direction fiber orientation in the spine direction at the point along the spine and +45°, −45°, and 90° fiber orientations with respect to the 0 direction in a plane at the point along the spine.

3. The method of claim 1, wherein simulating and displaying the part includes displaying in-plane and out-of-plane curvatures of the part.

4. The method of claim 1, wherein simulating and displaying the part includes displaying potential design and manufacturing problems including tensioning, compression, or buckling of the part.

5. The method of claim 1, wherein simulating and displaying the part includes displaying multiple spine-based rosettes along the spine.

6. The method of claim 1, wherein the spine-based rosette includes fiber orientations that are mapped to a location of the part away from the spine.

7. The method of claim 1, wherein simulating and displaying the part includes showing deviation of fibers in the simulated part from fiber orientations indicated by the spine-based rosette.

8. The method of claim 1, wherein the data processing system defines the spine by receiving a user indication of a curve to be used as the spine.

9. The method of claim 1, wherein an undeformed flat pattern of the material corresponding to the part model is computed from the simulation.

10. A data processing system, comprising:
a processor;
an accessible memory; and
a display, the data processing system configured to
receive a part model, the part model representing a part to be manufactured using a fiber composite material;
define a spine for the part model;
define a spine-based rosette for the part model; and
simulate and display the part according to the part model, the fiber composite material, the spine, and the spine-based rosette.

11. The data processing system of claim 10, wherein the spine-based rosette indicates fiber orientations for the part model at a point along the spine, the fiber orientations including a 0-direction fiber orientation in the spine direction at the point along the spine and +45°, −45°, and 90° fiber orientations with respect to the 0 direction in a plane at the point along the spine.

12. The data processing system of claim 10, wherein simulating and displaying the part includes displaying in-plane and out-of-plane curvatures of the part.

13. The data processing system of claim 10, wherein simulating and displaying the part includes displaying potential design and manufacturing problems including tensioning, compression, or buckling of the part.

14. The data processing system of claim 10, wherein simulating and displaying the part includes displaying multiple spine-based rosettes along the spine.

15. The data processing system of claim 10, wherein the spine-based rosette includes fiber orientations that are mapped to a location of the part away from the spine.

16. The data processing system of claim 10, wherein simulating and displaying the part includes showing deviation of fibers in the simulated part from fiber orientations indicated by the spine-based rosette.

17. The data processing system of claim 10, wherein the data processing system defines the spine by receiving a user indication of a curve to be used as the spine.

18. The data processing system of claim 10, wherein an undeformed flat pattern of the material is computed from the simulation.

19. A non-transitory machine-readable medium encoded with executable instructions that, when executed, cause at least one PDM data processing system to:
receive a part model, the part model representing a part to be manufactured using a fiber composite material;
define a spine for the part model;
define a spine-based rosette for the part model; and
simulate and display the part according to the part model, the fiber composite material, the spine, and the spine-based rosette.

20. The machine-readable medium of claim 19, wherein the spine-based rosette indicates fiber orientations for the part model at a point along the spine, the fiber orientations including a 0-direction fiber orientation in the spine direction at the point along the spine and +45°, −45°, and 90° fiber orientations with respect to the 0 direction in a plane at the point along the spine.

21. The machine-readable medium of claim 19 wherein simulating and displaying the part includes displaying in-plane and out-of-plane curvatures of the part and displaying potential design and manufacturing problems including tensioning, compression, or buckling of the part.

22. The machine-readable medium of claim 19, wherein simulating and displaying the part includes displaying multiple spine-based rosettes along the spine, and at least one spine-based rosette includes fiber orientations that are mapped to a location of the part away from the spine.

23. The machine-readable medium of claim 19, wherein simulating and displaying the part includes showing deviation of fibers in the simulated part from fiber orientations indicated by the spine-based rosette.

24. The machine-readable medium of claim 19, wherein an undeformed flat pattern of the material is computed from the simulation.
